(19) United States
(12) Patent Application Publication
(10) Pub. No.: US 2025/0333004 A1
(43) Pub. Date: Oct. 30, 2025

(54) TACTICAL DOOR CADDY DEVICE

(71) Applicant: Brian Milligan, Ormond Beach, FL (US)

(72) Inventor: Brian Milligan, Ormond Beach, FL (US)

(21) Appl. No.: 19/053,592

(22) Filed: Feb. 14, 2025

Related U.S. Application Data
(60) Provisional application No. 63/637,911, filed on Apr. 24, 2024.

(51) Int. Cl. B60R 7/08; B60R 7/04

(52) U.S. Cl. CPC B60R 7/08; B60R 7/046

(57) ABSTRACT

A tactical door caddy device is disclosed, which is a vehicle door organizer that accommodates law enforcement equipment, including, but not limited to rifle and handgun magazines, flashlights and similar items. The tactical door caddy device comprises a body component that is configured to integrate into a vehicle door pocket and typically comprises compressed foam of an approximate three inch thickness to accommodate the door pocket. Further, the body component comprises cutouts of specific shape and size to mirror the shape and size of the law enforcement equipment, which allows the cutouts to securely hold and organize the law enforcement equipment, as needed. Once inserted, the body component fits snug and firm for retention and easy accessibility of the law enforcement equipment.

### CROSS-REFERENCE TO RELATED APPLICATION

The present application claims priority to, and the benefit of, U.S. Provisional Application No. 63/637,911, which was filed on Apr. 24, 2024, and is incorporated herein by reference in its entirety.

### FIELD OF THE INVENTION

The present invention relates generally to the field of tactical door caddy devices. More specifically, the present invention relates to a vehicle door organizer for law enforcement equipment. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in tactical door caddy devices. Generally, law enforcement people need quick and easy access to life saving equipment, even while in their vehicle. There may be a lack of space inside a police vehicle to maintain easy access to firearms, flashlights, additional magazines, and other similar items. These items being unorganized can lead to officers not grabbing them quick enough and civilians losing their lives.

Additionally, unorganized equipment can result in lost and/or misplaced equipment. This equipment can become lost within the vehicle or misplaced resulting in unauthorized users having access to such equipment. Accordingly, when a user needs the equipment, they may not be able to find it, or they may not be able to find it quick enough.

Accordingly, there is a demand for an improved tactical door caddy device that fits inside a vehicle door. More particularly, there is a demand for a tactical door caddy device that includes special cutouts for each type of equipment to maintain organization and easy access.

Therefore, there exists a long felt need in the art for a tactical door caddy device that provides users with a vehicle door organizer that fits inside the vehicle's door pocket. There is also a long felt need in the art for a tactical door caddy device that functions as a storage and organization system for law enforcement equipment like flashlights, rifle and handgun magazines, and more. Further, there is a long felt need in the art for a tactical door caddy device that utilizes specific cutouts for each type of equipment to maintain organization and offer easy access. Moreover, there is a long felt need in the art for a device that saves time when accessing these types of items to prevent serious injury to other officers and civilians. Further, there is a long felt need in the art for a tactical door caddy device that is approximately three inches in thickness to accommodate the door pocket. Finally, there is a long felt need in the art for a tactical door caddy device that provides for organization of law enforcement equipment.

The subject matter disclosed and claimed herein, in one embodiment thereof, comprises a tactical door caddy device. The device is a vehicle door organizer that accommodates law enforcement equipment, including, but not limited to rifle and handgun magazines, flashlights and similar items. The tactical door caddy device comprises a body component that is configured to integrate into a vehicle door pocket and typically comprises compressed foam of an approximate three inch thickness to accommodate the door pocket. Further, the body component comprises cutouts of specific shape and size to mirror the shape and size of the law enforcement equipment, which allows the cutouts to securely hold and organize the law enforcement equipment, as needed. Once inserted, the body component fits snug and firm for retention and easy accessibility of the law enforcement equipment.

In this manner, the tactical door caddy device of the present invention accomplishes all of the forgoing objectives and provides users with a device that stores and organizes law enforcement equipment. The device is a foam insert with cutouts to be inserted into a door pocket. The device can be manufactured of a foam material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tactical door caddy device. The device is a vehicle door organizer that accommodates law enforcement equipment. The tactical door caddy device comprises a body component that is configured to integrate into a vehicle door pocket and comprises cutouts of specific shape and size to mirror the shape and size of the law enforcement equipment inserted within. Once inserted, the body component fits snug and firm for retention and easy accessibility of the law enforcement equipment.

In one embodiment, the tactical door caddy device allows for the quick and easy storage of life saving equipment, such as law enforcement equipment. Specifically, the tactical door caddy device is positioned within a vehicle and more specifically, within a vehicle's door pocket or other suitable, accessible area within the vehicle. The device functions as both a storage and organization system for all types of law enforcement equipment. Accordingly, the device allows users to quickly and efficiently retrieve the needed equipment, which can save lives.

In one embodiment, the tactical door caddy device stores and organizes lifesaving equipment. This lifesaving equipment includes, but is not limited to, law enforcement equipment typically used by military and law enforcement organizations worldwide. Further, the law enforcement equipment includes, but is not limited to, flashlights, rifle and handgun magazines, tasers, handcuffs, batons, pens, pencils, notepads, etc., or any other suitable equipment as is known in the art that might be needed by a law enforcement officer.

In one embodiment, the tactical door caddy device comprises a body component that is configured to integrate into a vehicle door pocket. Specifically, the body component can be of any suitable size and shape as is known in the art, as long as the body component is sized and shaped to fit within a vehicle door pocket. Accordingly, the body component is typically an elongated rectangular shape which can taper from one end to another. Thus, the body component is sized and shaped to be press fit into a vehicle door pocket, such that the body component does not jostle around within the door pocket but remains secure and in an upright position. Once inserted, the body component fits snug and firm for retention and easy accessibility of the law enforcement equipment it holds.

In one embodiment, the body component is positioned within a vehicle door pocket. Thus, the body component is sized to be inserted into the interior door sleeve or pocket of a standard vehicle. However, the body component can be inserted within any suitable position of the vehicle interior, depending on the needs and/or wants of a user. For example, the body component can be inserted into the middle, inner council of a vehicle, between the two front seats. Further, the body component can be inserted with a vehicle's glove box, or any other suitable position within the interior of the vehicle.

In one embodiment, the body component is comprised of a compressed foam or other suitable soft and flexible material. This flexible material allows the body component to be slightly compressed, then inserted into the vehicle door pocket and released, thus allowing the body component to conform to the shape of the vehicle door pocket interior and be held in place in an upright position. Further, the foam material typically comprises a compressed foam having an approximate three-inch thickness to accommodate the entire width of the door pocket. However, any suitable thickness can be utilized with the body component, depending on the width of the vehicle door pocket being used. Thus, once inserted within the door pocket, the body component takes up the width and volume of the entire door pocket, preventing the body component from jostling around when in use.

In one embodiment, the body component comprises a plurality of cutouts, wherein any suitable number of cutouts can be provided with the body component. In one embodiment, a specific number of cutouts are available in the body component. In another embodiment, the entire top surface of the body component can be configured with cutouts. Each cutout is of a specific shape and size to mirror the shape and size of the law enforcement equipment it will hold or retain. For example, each cutout is as shallow or as deep as needed to retain the equipment, depending on the size and/or length of the specific piece of equipment to be retained. Further, each cutout is sized and shaped to allow the specific law enforcement equipment to be press fit into the cutout, such that the law enforcement equipment does not fall out of the cutout and get lost within the vehicle, even while driving and being jostled around with the vehicle door opening and closing. Accordingly, the cutouts securely hold and organize the law enforcement equipment, allowing the law enforcement equipment to always be within arm's reach and easily accessible, as needed for the law enforcement officer.

In one embodiment, the body component can be arranged with a specific number of cutouts for holding specific law enforcement equipment, depending on the needs and/or wants of a user. For example, some of the cutouts can be sized and shaped to retain flashlights. Further, some of the cutouts can be sized and shaped to retain rifle and handgun magazines. Some of the cutouts can be sized and shaped to retain tasers. Additionally, some of the cutouts can be sized and shaped to retain handcuffs. Some of the cutouts can be sized and shaped to retain batons. Finally, some of the cutouts can be sized and shaped to retain pens, pencils, and notepads, etc., or the cutouts can be sized and shaped to retain any suitable law enforcement equipment as is known in the art, depending on the needs and/or wants of a user. Thus, multiple variations of the body component can be available and tailored to the specific wants and/or needs of a user.

In one embodiment, the plurality of cutouts include various shapes, such as slots, squares, circles, ovals, etc., or any other suitable shaped cutout to fit and retain a specific piece of law enforcement equipment. Typically, the plurality of cutouts are an array that is arranged in horizontal and vertical spaced apart rows on the top surface of the body component but can be arranged in any position on the top surface of the body component.

In one embodiment, the top surface of the body component may comprise a rubberized material or coating. Any suitable rubberized material can be utilized as is known in the art. The rubberized material or coating adds durability to the body component and prevents break-down of the cutouts. Thus, after repeated use of the insertion and removal of the multiple pieces of law enforcement equipment retained within the body component, the rubberized material or coating prevents the cutouts from breaking-down, fraying, or ripping apart after such repeated use. In another embodiment, the exterior rubberized material or coating may be printed with a particular coloring or with different color schemes or patterns to give the body component a desired appearance.

In one embodiment, the tactical door caddy device is manufactured from polyurethane foam, polyether foam, polyester foam, Etha foam, memory foam, cellulose, closed-cell foam, open-cell foam, or other suitable materials as is known in the art, or a combination of such materials.

In yet another embodiment, the tactical door caddy device comprises a plurality of indicia.

In yet another embodiment, a method of storing a plurality of law enforcement equipment for easy accessibility is disclosed. The method includes the steps of providing a tactical door caddy device comprising a body component with a plurality of cutouts. The method also comprises inserting the body component within a vehicle door pocket. Further, the method comprises inserting various law enforcement equipment into the plurality of cutouts of the body component. Finally, the method comprises having the law enforcement equipment organized and within reach for easy accessibility.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the tactical door caddy device of the present invention in use in accordance with the disclosed architecture;

FIG. 2 illustrates a perspective view of one embodiment of the tactical door caddy device of the present invention showing the law enforcement equipment to be stored with the device in accordance with the disclosed architecture;

FIG. 3 illustrates a perspective view of one embodiment of the tactical door caddy device of the present invention showing the cutouts for storing the equipment in accordance with the disclosed architecture;

FIG. 4 illustrates a perspective view of one embodiment of the tactical door caddy device of the present invention showing the body component of the device in accordance with the disclosed architecture; and

FIG. 5 illustrates a flowchart showing the method of storing a plurality of law enforcement equipment for easy accessibility in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a tactical door caddy device that provides users with a vehicle door organizer that fits inside the vehicle's door pocket. There is also a long felt need in the art for a tactical door caddy device that functions as a storage and organization system for law enforcement equipment like flashlights, rifle and handgun magazines, and more. Further, there is a long felt need in the art for a tactical door caddy device that utilizes specific cutouts for each type of equipment to maintain organization and offer easy access. Moreover, there is a long felt need in the art for a device that saves time when accessing these types of items to prevent serious injury to other officers and civilians. Further, there is a long felt need in the art for a tactical door caddy device that is approximately three inches in thickness to accommodate the door pocket. Finally, there is a long felt need in the art for a tactical door caddy device that provides for organization of law enforcement equipment.

The present invention, in one exemplary embodiment, is a novel tactical door caddy device. The tactical door caddy device comprises a body component that is configured to integrate into a vehicle door pocket and typically comprises compressed foam of an approximate three inch thickness to accommodate the door pocket. Further, the body component comprises cutouts of specific shape and size to mirror the shape and size of the law enforcement equipment, which allows the cutouts to securely hold and organize the law enforcement equipment, as needed. Once inserted, the body component fits snug and firm for retention and easy accessibility of the law enforcement equipment. The present invention also includes a novel method of storing a plurality of law enforcement equipment for easy accessibility. The method includes the steps of providing a tactical door caddy device comprising a body component with a plurality of cutouts. The method also comprises inserting the body component within a vehicle door pocket. Further, the method comprises inserting various law enforcement equipment into the plurality of cutouts of the body component. Finally, the method comprises having the law enforcement equipment organized and within reach for easy accessibility. The device may be used by any individual including, but not limited to, outdoors men/women, adventurers, etc.

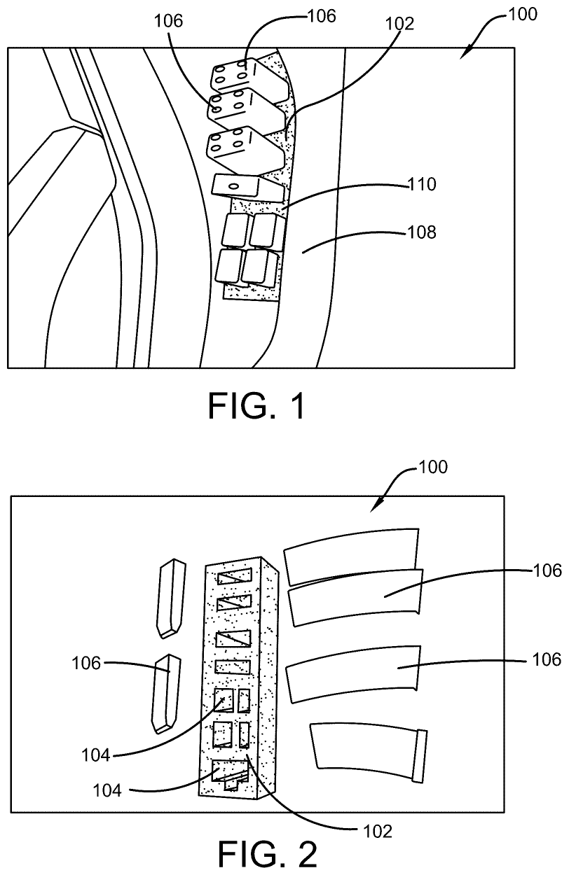

Referring initially to the drawings, FIG. 1 illustrates a perspective view of one embodiment of the tactical door caddy device 100 of the present invention. In the present embodiment, the tactical door caddy device 100 is an improved tactical door caddy device 100 that provides a user with a door organizer for law enforcement equipment 106. Specifically, the tactical door caddy device 100 comprises a body component 102 with a plurality of cutouts 104, which is positioned within a vehicle door pocket 108. Once inserted, the body component 102 fits snug and firm for retention and easy accessibility of the law enforcement equipment 106 stored within the plurality of cutouts 104.

Generally, the tactical door caddy device 100 allows for the quick and easy storage of life saving equipment, such as law enforcement equipment 106. Specifically, the tactical door caddy device 100 is positioned within a vehicle and more specifically, within a vehicle's door pocket 108 or other suitable, accessible area within the vehicle. The device 100 functions as both a storage and organization system for all types of law enforcement equipment 106. Accordingly, the device 100 allows users to quickly and efficiently retrieve the needed equipment 106, which can save lives.

Further, the tactical door caddy device 100 comprises a body component 102 that is configured to integrate into a vehicle door pocket 108. Specifically, the body component 102 can be of any suitable size and shape as is known in the art, as long as the body component 102 is sized and shaped to fit within a vehicle door pocket 108. Accordingly, the body component 102 is typically an elongated rectangular shape which can taper from one end to another. Thus, the body component 102 is sized and shaped to be press fit into a vehicle door pocket 108, such that the body component 102 does not jostle around within the door pocket 108 but remains secure and in an upright position. Once inserted, the body component 102 fits snug and firm for retention and easy accessibility of the law enforcement equipment 106 it holds.

Additionally, the body component 102 is positioned within a vehicle door pocket 108. Thus, the body component 102 is sized to be inserted into the interior door sleeve or pocket 108 of a standard vehicle. However, the body component 102 can be inserted within any suitable position of the vehicle interior, depending on the needs and/or wants of a user. For example, the body component 102 can be inserted into the middle, inner council of a vehicle, between the two front seats. Further, the body component 102 can be inserted with a vehicle's glove box, or any other suitable position within the interior of the vehicle.

Furthermore, the body component 102 is comprised of a compressed foam or other suitable soft and flexible material. This flexible material allows the body component 102 to be slightly compressed, then inserted into the vehicle door pocket 108 and released, thus allowing the body component 102 to conform to the shape of the vehicle door pocket interior and be held in place in an upright position. Further, the foam material typically comprises a compressed foam having an approximate three-inch thickness to accommodate the entire width of the door pocket 108. However, any suitable thickness can be utilized with the body component 102, depending on the width of the vehicle door pocket 108 being used. Thus, once inserted within the door pocket 108, the body component 102 takes up the width and volume of the entire door pocket 108, preventing the body component 102 from jostling around when in use.

As shown in FIG. 2, the tactical door caddy device 100 stores and organizes lifesaving equipment. This lifesaving equipment includes, but is not limited to, law enforcement equipment 106 typically used by military and law enforcement organizations worldwide. Further, the law enforcement equipment 106 includes, but is not limited to, flashlights, rifle and handgun magazines, tasers, handcuffs, batons, pens, pencils, notepads, etc., or any other suitable equipment as is known in the art that might be needed by a law enforcement officer.

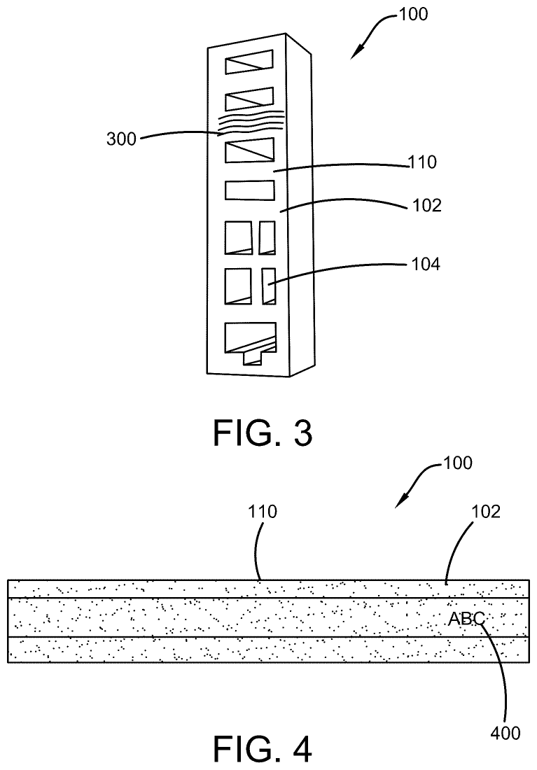

As shown in FIG. 3, the body component 102 comprises a plurality of cutouts 104, wherein any suitable number of cutouts can be provided with the body component 102. In one embodiment, a specific number of cutouts 104 are available in the top surface 110 of the body component 102. In another embodiment, the entire top surface 110 of the body component 102 can be configured with cutouts 104. Each cutout 104 is of a specific shape and size to mirror the shape and size of the law enforcement equipment 106 it will hold or retain. For example, each cutout 104 is as shallow or as deep as needed to retain the equipment 106, depending on the size and/or length of the specific piece of equipment 106 to be retained. Further, each cutout 104 is sized and shaped to allow the specific law enforcement equipment 106 to be press fit into the cutout 104, such that the law enforcement equipment 106 does not fall out of the cutout 104 and get lost within the vehicle, even while driving and being jostled around with the vehicle door opening and closing. Accordingly, the cutouts 104 securely hold and organize the law enforcement equipment 106, allowing the law enforcement equipment 106 to always be within arm's reach and easily accessible, as needed for the law enforcement officer.

Further, the body component 102 can be arranged with a specific number of cutouts 104 for holding specific law enforcement equipment 106, depending on the needs and/or wants of a user. For example, some of the cutouts 104 can be sized and shaped to retain flashlights. Further, some of the cutouts 104 can be sized and shaped to retain rifle and handgun magazines. Some of the cutouts 104 can be sized and shaped to retain tasers. Additionally, some of the cutouts 104 can be sized and shaped to retain handcuffs. Some of the cutouts 104 can be sized and shaped to retain batons. Finally, some of the cutouts 104 can be sized and shaped to retain pens, pencils, and notepads, etc., or the cutouts 104 can be sized and shaped to retain any suitable law enforcement equipment 106 as is known in the art, depending on the needs and/or wants of a user. Thus, multiple variations of the body component 102 can be available and tailored to the specific wants and/or needs of a user.

Additionally, the plurality of cutouts 104 include various shapes, such as slots, squares, circles, ovals, etc., or any other suitable shaped cutout 104 to fit and retain a specific piece of law enforcement equipment 106. Typically, the plurality of cutouts 104 are an array that is arranged in horizontal and vertical spaced apart rows on the top surface 110 of the body component 102 but can be arranged in any position on the top surface 110 of the body component 102.

Furthermore, the top surface 110 of the body component 102 may comprise a rubberized material or coating 300. Any suitable rubberized material 300 can be utilized as is known in the art. The rubberized material or coating 300 adds durability to the body component 102 and prevents break-down of the cutouts 104. Thus, after repeated use of the insertion and removal of the multiple pieces of law enforcement equipment 106 retained within the body component 102, the rubberized material or coating 300 prevents the cutouts 104 from breaking-down, fraying, or ripping apart after such repeated use. In another embodiment, the exterior rubberized material or coating 300 may be printed with a particular coloring or with different color schemes or patterns to give the body component 102 a desired appearance.

As shown in FIG. 4, the tactical door caddy device 100 is manufactured from polyurethane foam, polyether foam, polyester foam, Etha foam, memory foam, cellulose, closed-cell foam, open-cell foam, or other suitable materials as is known in the art, or a combination of such materials.

In yet another embodiment, the tactical door caddy device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be law enforcement, vehicle, or brand related.

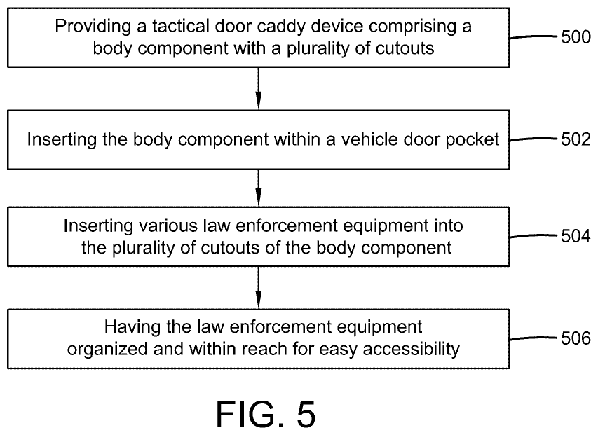

FIG. 5 illustrates a flowchart of the method of storing a plurality of law enforcement equipment for easy accessibility. The method includes the steps of at 500, providing a tactical door caddy device comprising a body component with a plurality of cutouts. The method also comprises at 502, inserting the body component within a vehicle door pocket. Further, the method comprises at 504, inserting various law enforcement equipment into the plurality of cutouts of the body component. Finally, the method comprises at 506, having the law enforcement equipment organized and within reach for easy accessibility.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tactical door caddy device”, “tactical device”, “door caddy device”, and “device” are interchangeable and refer to the tactical door caddy device 100 of the present invention.

Notwithstanding the forgoing, the tactical door caddy device 100 of the present invention can be of any suitable size and configuration as is known in the art without affecting the overall concept of the invention, provided that it accomplishes the above stated objectives. One of ordinary skill in the art will appreciate that the tactical door caddy device 100 as shown in FIGS. 1-5 is for illustrative purposes only, and that many other sizes and shapes of the tactical door caddy device 100 are well within the scope of the present disclosure. Although the dimensions of the tactical door caddy device 100 are important design parameters for user convenience, the tactical door caddy device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tactical door caddy device that provides a user with a door organizer for law enforcement equipment, the tactical door caddy device comprising:
a body component; and
a plurality of cutouts;
wherein the plurality of cutouts are positioned within the body component;
wherein the body component is positioned within a vehicle door pocket; and
further wherein the plurality of cutouts retain law enforcement equipment for organization and easy accessibility.

2. The tactical door caddy device of claim 1, wherein the body component is an elongated rectangular shape which can taper from one end to another.

3. The tactical door caddy device of claim 2, wherein the body component is sized and shaped to be press fit into a vehicle door pocket, such that the body component does not jostle around within the vehicle door pocket but remains secure and in an upright position.

4. The tactical door caddy device of claim 3, wherein the body component is comprised of a compressed foam.

5. The tactical door caddy device of claim 4, wherein the body component is slightly compressed, then inserted into the vehicle door pocket and released, thus allowing the body component to conform to shape of the vehicle door pocket interior and be held in place in an upright position.

6. The tactical door caddy device of claim 5, wherein the body component has an approximate three-inch thickness to accommodate an entire width of the vehicle door pocket.

7. The tactical door caddy device of claim 6, wherein the law enforcement equipment comprises a flashlight, a rifle and handgun magazines, a taser, a handcuff, a baton, a pen, a pencil, and a notepad.

8. The tactical door caddy device of claim 7, wherein each of the plurality of cutouts is of a specific shape and size to mirror shape and size of the specific law enforcement equipment it will hold or retain.

9. The tactical door caddy device of claim 8, wherein each of the plurality of cutouts is sized and shaped to allow the specific law enforcement equipment to be press fit into the cutout, such that the law enforcement equipment does not fall out of the cutout and get lost within the vehicle.

10. The tactical door caddy device of claim 9, wherein the plurality of cutouts include various shapes, such as slots, squares, circles, or ovals.

11. The tactical door caddy device of claim 10, wherein the plurality of cutouts are an array that is arranged in horizontal and vertical spaced apart rows on the top surface of the body component.

12. The tactical door caddy device of claim 11, wherein the top surface of the body component may comprise a rubberized coating for durability of the plurality of cutouts.

13. A tactical door caddy device that provides a user with a door organizer for law enforcement equipment, the tactical door caddy device comprising:
a body component which is an elongated rectangular shape which can taper from one end to another; and
a plurality of cutouts each of a specific shape and size to mirror shape and size of specific law enforcement equipment it will hold or retain;
wherein the plurality of cutouts include various shapes, such as slots, squares, circles, or ovals, which are positioned within the body component;
wherein the body component is sized and shaped to be press fit into a vehicle door pocket, such that the body component does not jostle around within the vehicle door pocket but remains secure and in an upright position;
wherein the body component is slightly compressed, then inserted into the vehicle door pocket and released, thus allowing the body component to conform to shape of the vehicle door pocket interior and be held in place in an upright position;
wherein the body component has an approximate three-inch thickness to accommodate an entire width of the vehicle door pocket;
wherein each of the plurality of cutouts is sized and shaped to allow the specific law enforcement equipment to be press fit into the cutout, such that the law enforcement equipment does not fall out of the cutout and get lost within the vehicle; and
further wherein the plurality of cutouts retain law enforcement equipment for organization and easy accessibility.

14. The tactical door caddy device of claim 13 wherein the law enforcement equipment comprises a flashlight, a rifle and handgun magazine, a taser, a handcuff, a baton, a pen, a pencil and a notepad.

15. The tactical door caddy device of claim 13, wherein the plurality of cutouts are an array that is arranged in horizontal and vertical spaced apart rows on the top surface of the body component.

16. The tactical door caddy device of claim 13, wherein the top surface of the body component may comprise a rubberized coating for durability of the plurality of cutouts.

17. The tactical door caddy device of claim 16, wherein the exterior rubberized coating may be printed with a particular coloring or with different color schemes or patterns to give the body component a desired appearance.

18. The tactical door caddy device of claim 13, wherein the body component is manufactured from a polyurethane foam, a polyether foam, a polyester foam, an Etha foam, a memory foam, a cellulose, a closed-cell foam, an open-cell foam, or a combination thereof.

19. The tactical door caddy device of claim 13 further comprising a plurality of indicia.

20. A method of storing a plurality of law enforcement equipment for easy accessibility, the method comprising the following steps:
providing a tactical door caddy device comprising a body component with a plurality of cutouts;
inserting the body component within a vehicle door pocket;
inserting various law enforcement equipment into the plurality of cutouts of the body component; and
having the law enforcement equipment organized and within reach for easy accessibility.
